(19) United States
(12) Patent Application Publication
(10) Pub. No.: US 2003/0220436 A1
(43) Pub. Date: Nov. 27, 2003

(54) Biodegradable polymers containing one or more inhibitors and methods for producing same

(76) Inventors: Mehmet A. Gencer, Brecksville, OH (US); Donald A. Kubik, Dickenson, ND (US); Ramani Narayan, Okemos, MI (US); Boris G. Varshal, Lynn, MA (US); Efim Ya. Lyublinski, Mayfield Heights, OH (US); Barbara A. Nygaard, Circle Pines, MN (US)

Correspondence Address: Alfred D. Lobo, LOBO & CO., L.P.A., 933 Leader Building, 526 Superior Avenue, E., Cleveland, OH, 44114-1902, US

(21) Appl. No.: 10/396,067

(22) Filed: Mar. 25, 2003

Related U.S. Application Data
(63) Continuation-in-part of application No. 10/054,031, filed on Jan. 22, 2002, now abandoned.
(63) Continuation-in-part of application No. 10/054,032, filed on Jan. 22, 2002, now abandoned.

(51) Int. Cl. C08K 5/17; C08K 5/33; C08K 3/34; C08K 11/00

(52) U.S. Cl. 524/492; 524/442; 524/236; 524/384

(57) ABSTRACT

The present invention relates to biodegradable polymers which can be combined with, impregnated with and/or encapsulate one or more inhibiting formulas. More particularly, in one embodiment the present invention relates to a biodegradable polyester polymer which has been combined with, impregnated with and/or encapsulates one or more inhibiting formulas. This polymer composition can then be further processed into any suitable article. In another embodiment, the present invention relates to a biodegradable polyester polymer which has been combined with, impregnated with and/or encapsulates a desired amount of one or more tarnish and/or corrosion inhibiting formulas. In another embodiment, the one or more tarnish and/or corrosion inhibiting formulas can be dispersed within and through a suitable biodegradable polymer film.

### RELATED APPLICATIONS

This application is a continuation-in-part of co-pending application U.S. Ser. No. 10/054,031, filed Jan. 22, 2002, entitled “Corrosion Inhibiting Formula and Corrosion Inhibiting Articles Using Same”, and a continuation-in-part of co-pending application U.S. Ser. No.10/054,032, filed Jan. 22, 2002, entitled “Tarnish Inhibiting Formula and Tarnish Inhibiting Articles Using Same”.

### FIELD OF THE INVENTION

The present invention relates to biodegradable polymers which can be combined with, impregnated with and/or used to encapsulate one or more inhibiting formulas or compounds (e.g., corrosion inhibiting or tarnish inhibiting formulas). More particularly, in one embodiment the present invention relates to biodegradable polyester or copolyester polymers, their blends or blends thereof, which contain one or more starch, thermoplastic starch or thermoplastic proteins which have been combined with, impregnated with and/or encapsulates one or more inhibiting formulas or compounds. This polymer composition can then be further processed into any suitable article. In another embodiment, the present invention relates to biodegradable polyester or copolyester polymers, their blends, or blends thereof which contain one or more starch, thermoplastic starch or thermoplastic proteins which have been combined with, impregnated with and/or encapsulates a desired amount of one or more tarnish and/or corrosion inhibiting formulas or compounds. In another embodiment, the one or more tarnish and/or corrosion inhibiting formulas or compounds can be dispersed within and through a suitable biodegradable polymer film.

### BACKGROUND OF THE INVENTION

In commerce and industry today, the useful life of a variety of items may be extended and/or preserved by providing one or more suitable inhibitors. An inhibitor is a compound or group of compounds which can slow or negate the rate of decomposition, degradation and/or spoilage of a given item due to, for example, corrosion or oxidation. For example, certain metals are prone to corrosion and/or tarnishing. A suitable inhibitor, in such a case, would be a compound (or group of compounds) which acts as a corrosion and/or tarnish inhibitor thereby protecting a desired item or items from the adverse effects of its ambient environment.

Among the common indications of corrosion manifested in useful metallic articles are oxidation, pitting, tarnishing, mottling or discoloration of the surfaces of these items. Another example of undesirable decomposition, degradation and/or spoilage is the spoilage of food stuffs due to oxidation.

To date, most sheet materials used in packaging which contain therein an inhibiting formula have been made from conventional non-degradable polymers. However, when a film substrate has served its intended purpose and is to be discarded, it is becoming more and more important that the composition from which the film is formed be biodegradable and compostable. Indeed, certain environmental legislation has been proposed which would ban the disposal of bags fabricated from non-biodegradable plastic film from compost heaps or piles. In this connection, standards have been adopted for classifying film bags as compostable and biodegradable, with this standard normally providing that 90% of the carbon of the film is converted to CO₂ and biomass within a maximum time period of six months in a compost environment wherein the film is the sole carbon source available, and that no more than 10% of the film's original weight can remain on a ⅜th-inch screen following 12 weeks of exposure to a compost medium.

It is recognized that biodegradable films are more environmentally friendly, since the biodegradation of the film renders it more acceptable for use in situations where composting will occur or must occur. It is desirable to have a biodegradable film having similar mechanical and physical properties to those of non-biodegradable while still permitting the incorporation therein of one or more inhibiting formulas. Additional environmental advantages can be obtained by using a polymer film which is derived from a renewable agricultural resource due to the renewable nature of the source of raw material for the polymer film.

### SUMMARY OF THE INVENTION

In accordance with one embodiment, the present invention relates to a biodegradable polymer article comprising a biodegradable polyester or copolyester polymer, their blends or blends thereof which contain one or more starch, thermoplastic starch or thermoplastic proteins and at least one formula selected from:

(1) a formula which comprises:

(1a) at least one volatile corrosion inhibitor;

(1b) at least one anti-oxidant;

(1c) at least one alkali or alkaline-earth metal silicate or oxide; and

(1d) fumed silica,

(2) a formula which comprises:

(2a) at least one volatile corrosion inhibitor;

(2b) at least one anti-oxidant;

(2c) at least one alkali or alkaline-earth metal silicate or oxide;

(2d) fumed silica; and

(2e) at least one chemically active compound,

(3) a formula which comprises:

(3a) an inorganic nitrite salt; and

(3b) a phenol represented by the formula:

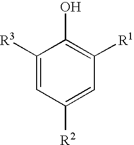

where R¹, R² and R³ are each independently selected from alkyl, aryl, alkenyl, hydroxyalkyl and hydroxyalkenyl, and where the sum of carbon atoms in R¹, R² and R³ is in the range of 3 to about 18; and

(3c) fumed silica, or

(4) a formula which comprises:

(4a) at least one strong alkali compound; and

(4b) at least one compound which yields an insoluble compound.

In another embodiment, the present invention relates to a biodegradable polymer article comprising a biodegradable polyester or copolyester polymer, their blends or blends thereof which contain one or more starch, thermoplastic starch or thermoplastic proteins and at least one formula selected from:

(1) a formula which comprises:

(1a) at least one volatile corrosion inhibitor;

(1b) at least one anti-oxidant;

(1c) at least one alkali or alkaline-earth metal silicate or oxide; and

(1d) fumed silica,

(2) a formula which comprises:

(2a) at least one volatile corrosion inhibitor;

(2b) at least one anti-oxidant;

(2c) at least one alkali or alkaline-earth metal silicate or oxide;

(2d) fumed silica; and

(2e) at least one chemically active compound,

(3) a formula which comprises:

(3a) an inorganic nitrite salt;

(3b) a phenol represented by the formula:

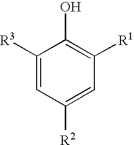

where R¹, R² and R³ are each independently selected from alkyl, aryl, alkenyl, hydroxyalkyl and hydroxyalkenyl, and where the sum of carbon atoms in R¹, R² and R³ is in the range of 3 to about 18; and

(3c) fumed silica, or

(4) a formula which comprises:

(4a) at least one strong alkali compound; and

(4b) at least one compound which yields an insoluble compound,

wherein the at least one formula is present in an amount in the range of about 0.5 to about 5 percent by weight.

In another embodiment, the present invention relates to a biodegradable polymer article comprising a biodegradable polyester or copolyester polymer, their blends or blends thereof which contain one or more starch, thermoplastic starch or thermoplastic proteins and at least one formula selected from:

(1) a formula which comprises:

(1a) at least one volatile corrosion inhibitor;

(1b) at least one anti-oxidant;

(1c) at least one alkali or alkaline-earth metal silicate or oxide; and

(1d) fumed silica,

(2) a formula which comprises:

(2a) at least one volatile corrosion inhibitor;

(2b) at least one anti-oxidant;

(2c) at least one alkali or alkaline-earth metal silicate or oxide;

(2d) fumed silica; and

(2e) at least one chemically active compound,

(3) a formula which comprises:

(3a) an inorganic nitrite salt;

(3b) a phenol represented by the formula:

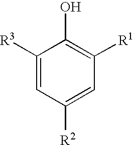

where R¹, R² and R³ are each independently selected from alkyl, aryl, alkenyl, hydroxyalkyl and hydroxyalkenyl, and where the sum of carbon atoms in R¹, R² and R³ is in the range of 3 to about 18; and

(3c) fumed silica, or

(4) a formula which comprises:

(4a) at least one strong alkali compound; and

(4b) at least one compound which yields an insoluble compound,

wherein the at least one formula is present in an amount in the range of about 20 to about 80 percent by weight.

In yet another embodiment, the present invention relates to a method for producing a biodegradable film containing at least one inhibiting formula comprising the steps of: (A) combining at least one inhibiting formula with a biodegradable polyester or copolyester polymer, their blends or blends thereof which contain one or more starch, thermoplastic starch or thermoplastic proteins to form a mixture; and (B) extruding the mixture in an extruder to form a biodegradable polymer film, wherein the at least one inhibiting formula is selected from:

(1) a formula which comprises:

(1a) at least one volatile corrosion inhibitor;

(1b) at least one anti-oxidant;

(1c) at least one alkali or alkaline-earth metal silicate or oxide; and

(1d) fumed silica,

(2) a formula which comprises:

(2a) at least one volatile corrosion inhibitor;

(2b) at least one anti-oxidant;

(2c) at least one alkali or alkaline-earth metal silicate or oxide;

(2d) fumed silica; and

(2e) at least one chemically active compound,

(3) a formula which comprises:

(3a) an inorganic nitrite salt;

(3b) a phenol represented by the formula:

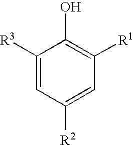

where R¹, R² and R³ are each independently selected from alkyl, aryl, alkenyl, hydroxyalkyl and hydroxyalkenyl, and where the sum of carbon atoms in R¹, R² and R³ is in the range of 3 to about 18; and

(3c) fumed silica, or

(4) a formula which comprises:

(4a) at least one strong alkali compound; and

(4b) at least one compound which yields an insoluble compound.

In yet another embodiment, the present invention relates to a method for producing a biodegradable film containing at least one inhibiting formula comprising the steps of: (A) combining at least one inhibiting formula with a biodegradable monomer and a catalyst; (B) processing the mixture of step (A) to form a biodegradable polymer; and (C) extruding the mixture in an extruder to form a biodegradable polymer film, wherein the inhibiting formula is selected from:

(1) a formula which comprises:

(1a) at least one volatile corrosion inhibitor;

(1b) at least one anti-oxidant;

(1c) at least one alkali or alkaline-earth metal silicate or oxide; and

(1d) fumed silica,

(2) a formula which comprises:

(2a) at least one volatile corrosion inhibitor;

(2b) at least one anti-oxidant;

(2c) at least one alkali or alkaline-earth metal silicate or oxide;

(2d) fumed silica; and

(2e) at least one chemically active compound,

(3) a formula which comprises:

(3a) an inorganic nitrite salt;

(3b) a phenol represented by the formula:

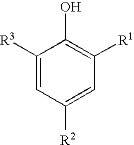

where R¹, R² and R³ are each independently selected from alkyl, aryl, alkenyl, hydroxyalkyl and hydroxyalkenyl, and where the sum of carbon atoms in R¹, R² and R³ is in the range of 3 to about 18; and

(3c) fumed silica, or

(4) a formula which comprises:

(4a) at least one strong alkali compound; and

(4b) at least one compound which yields an insoluble compound.

In another embodiment, the present invention relates to a biodegradable polymer article comprising a biodegradable polymer selected from star-poly (ε-caprolactone) and linear poly (ε-caprolactone), biodegradable aromatic-aliphatic copolyesters and at least one inhibiting formula selected from corrosion inhibitors, tarnish inhibitors, UV-protectants or mixtures of two or more thereof.

To the accomplishment of the foregoing and related ends, the invention, then, comprises the features hereinafter fully described and particularly pointed out in the claims. These embodiments are indicative, however, of but a few of the various ways in which the principles of the invention may be employed. Other objects, advantages and features of the invention will become apparent from the following detailed description of the invention.

### BRIEF DESCRIPTION OF THE DRAWINGS

FIG. 1 illustrates an exemplary screw configuration of a twin screw extruder for use in producing biodegradable plastic resins which contain one or more inhibiting formulas or compounds which can be blown or cast into film or further processed into a finished article; and

FIG. 2 is a graph of an exemplary pressure gradient that is observed during extrusion compounding to produce biodegradable plastic resins according to the present invention which contain one or more inhibiting formulas or compounds.

### DETAILED DESCRIPTION OF THE INVENTION

As noted above, the present invention relates to biodegradable polymers which can be combined with, impregnated with and/or used to encapsulate one or more inhibiting formulas or compounds. More particularly, in one embodiment the present invention relates to biodegradable polyester or copolyester polymers or their blends which have been combined with, impregnated with and/or used to encapsulate one or more inhibiting formulas or compounds. In another embodiment, a polyester or copolyester blend may contain one or more starch, thermoplastic starch or thermoplastic proteins, the polymer compounds being combined with, impregnated with and/or used to encapsulate one or more inhibiting formulas or compounds. This polymer composition can then be further processed into any suitable article.

In still another embodiment, the present invention relates to biodegradable polyester or copolyester polymers or their blends which have been combined with, impregnated with and/or used to encapsulate one or more corrosion and/or tarnish inhibiting formulas or compounds. In another embodiment, a polyester or copolyester blend may contain one or more starch, thermoplastic starch or thermoplastic proteins, the polymer compounds being combined with, impregnated with and/or used to encapsulate one or more corrosion and/or tarnish inhibiting formulas or compounds. These polymer compositions can also be subjected to further processing to yield any suitable article.

In another embodiment, the one or more tarnish and/or corrosion inhibiting formulas or compounds can be dispersed within and through a suitable biodegradable polymer film.

Additionally, it should be noted that in the following text, where utilized, range and ratio limits may be combined.

### Biodegradable Polymers

In one embodiment, the present invention relates to biodegradable polymers (e.g., biodegradable polyesters and/or copolyesters) which can be combined with, impregnated with or used to encapsulate one or more inhibiting formulas or compounds (e.g., tarnish and/or corrosion). A general discussion of biodegradable polymers follows. However, the present invention is not restricted thereto. Rather, the present invention can be utilized to produce a variety of biodegradable polyester polymer resins which contain one or more inhibiting formulas or compounds (e.g., corrosion inhibiting or tarnish inhibiting).

In one embodiment, the biodegradable polymer utilized in the present invention is linear poly (6-caprolactone) (as referred to as PCL). PCL TONE 787 (a trade designation) is a commercial aliphatic polyester polymer produced by Union Carbide (now a part of Dow Chemical Corporation) in a batch process using stannous octoate as the catalyst with a residence time of around 4 hours and at a temperature of around 170° C. A linear polyester with Mn around about 70,000 or lower is produced. Poly(ε-caprolactone) is a fully biodegradable polyester and passes the ASTM and ISO Standards of biodegradability and compostability.

In another embodiment, the biodegradable polymer utilized in the present invention is star poly (ε-caprolactone) and reactive blends of star poly (ε-caprolactone) with other biodegradable polyesters. A reactive extrusion polymerization approach using twin screw extruders to prepare biodegradable polyesters and copolyesters and blends with thermoplastic starch is disclosed in U.S. Pat. Nos. 5,500,465; 5,801,224; 5,906,783; and 5,969,089, all of which are incorporated herein in their entirety. Star PCL is produced by the reactive extrusion polymerization of P-caprolactone monomer in a co-rotating twin-screw extruder (ZSK-30) using aluminum tri-sec butoxide as the catalyst. Controlling the ratio of the monomer and the initiator permits one to control the molecular weight of the final polymer produced. Via the processes disclosed in the above-mentioned patents, one can obtain a multi-arm, branched polycaprolactone polymer having Mₙ values greater than about 100,000 and M_{w} values around about 300 to about 400,000 with residence times on the order of 3 to 4 minutes.

A twin screw extruder may be utilized to provide superior mixing, temperature control, positive conveying of materials and other features (e.g., multiple feed ports, vacuum ports or ability to change the configuration of the screw elements). Reactive extrusion makes it possible to combine the steps of melting, mixing, compatabilization, pelletizing or profile extruding/molding into one economical step. The extruder can be optionally equipped with gravimetric feeders suitable for powders/pellets/short fibers.

In another embodiment, a biodegradable polyester or copolyester can be blended with a plasticized starch or protein which has been plasticized by compounding the desired starch or protein with a suitable plasticizer (e.g., glycerol or other poly hydroxyl compounds). Examples of suitable starches and/or proteins which may be blended with the above-mentioned biodegradable polyesters include, but are not limited to, high amylose starch, yellow dent corn starch, potato starch, tapioca starch, waxy maize starch, wheat starch, soy protein, wheat gluten and corn protein.

In one embodiment, the amount of starch or protein added to one or more biodegradable polyesters or copolyesters is from about 5 to about 50 percent by weight, or from about 10 to about 40 percent by weight, or even from about 15 to about 35 percent by weight.

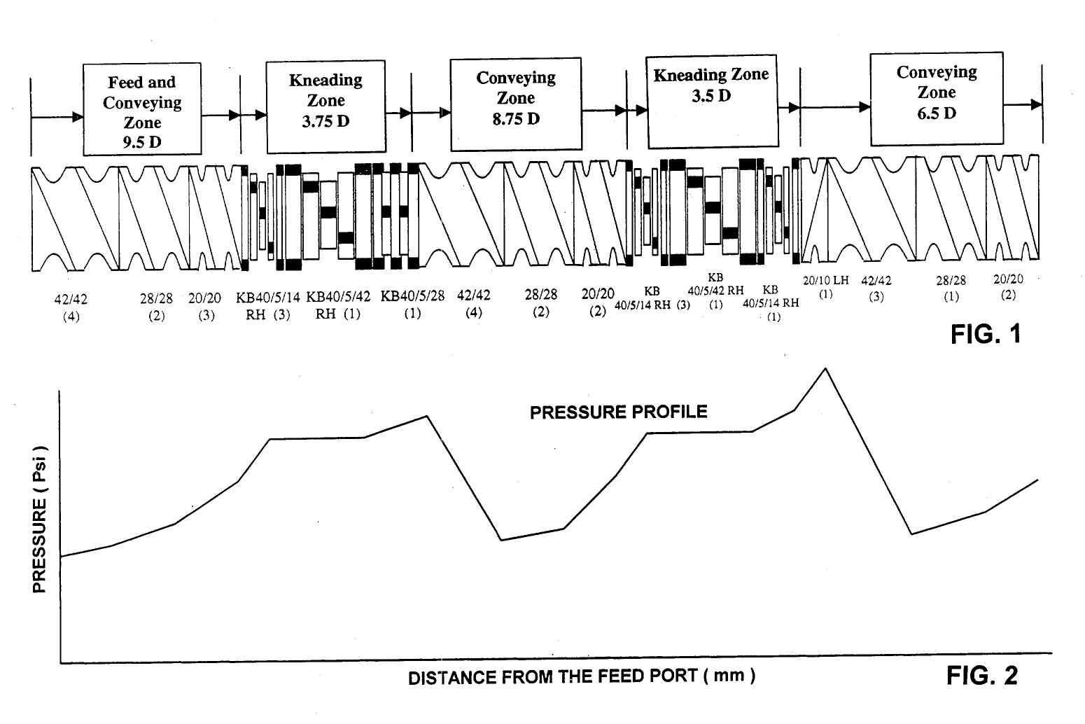

Reactive blending of the biodegradable polyesters with starch or protein polymers offers the advantages of cost reduction, enhanced rate of biodegradation and the eco-advantage of using a renewable agricultural resource. Downstream compounding of the plastic starch with the aliphatic polyester or copolyester results in grafting of the polyester chains on to the starch, and the in situ generated graft copolymer is able to compatibilize the two phases giving better properties to the resulting blend. In one embodiment, the thermoplastic starch can be compounded with an aliphatic polyester in the conveying zone as shown in FIG. 1. In another embodiment, the thermoplastic starch can be compounded with an aliphatic polyester 14 to 18D down the extruder from the feed port. By controlling the volume and/or viscosity ratio of the plastic starch to PCL in the extruder, it is possible to obtain a morphology in which the plastic starch is dispersed in a continuous PCL matrix phase. Good adhesion and compatibilization is promoted between the plastic-starch phase and the modified polyester phase thereby permitting enhanced mechanical properties.

Some of the advantages of using plasticized starch instead of granular starch are: 1) smaller domain size is possible by controlling rheological characteristics; 2) 10 improved strength and processing characteristics; and 3) reduced macroscopic dimensions in certain applications (i.e., film thickness). In one embodiment, any one or all of the above operations can be performed in a suitable extruder which allows for the elimination of a solvent, reduces the number of steps and simplifies the process. From an environmental perspective, a biodegradable product reduces waste and energy consumption and conserves resources. Table I shows the properties of the film that can be achieved, and it can be readily seen that the properties are comparable to low density polyethylene film (LDPE) and better than pure polycaprolactone film. The samples below are conditioned at a relative humidity of 40% at 72° C. for a period of 24 hours prior to testing. Additionally, the numbers in parentheses represent samples conditioned at a relative humidity of 90% at 72° C. for a period of 24 hours prior to testing. Testing of the samples is carried out according to ASTM D 882.

TABLE I

| | Tensile Strength | Elongation | Dart | | |
|---|---|---|---|---|---|
| Material | at Yield (PSI) | (Percent) | (grams) | Tear | Puncture |
| Starch-PCL | MD 2404/(2034) | MD 257/(465) | 137 | MD 81.5/(167) | 3.8/(4.6) |
| (Envar) | CMD 2098/(1735) | CMD 465/(322) | | CMD 208/(397) | |
| PCL | MD 3680 | MD 360 | <30 | MD 17 | — |
| | CMD 1840 | CMD 260 | | CMD 360 | |
| LDPE | approx. 2000 | 230-500 | 50-150 | 100-300 | 1.5-3.0 |

In another embodiment, aliphatic polyesters and copolyesters prepared by the step of polymerization involving condensation of a hydroxy carboxylic acid monomer or a diol with a dicarboxylic acid can be utilized as the biodegradable polymer of the present invention. Aliphatic polyesters and copolyesters are susceptible to biodegradation directly through action of non-specific enzymes, like esterases secreted by microorganisms or undergo hydrolysis to the monomer, which undergoes subsequent biodegradation. Several biodegradable plastic resin technologies based on aliphatic polyesters and copolyesters have emerged spearheaded by Eastman Chemical, DuPont, BASF, Mitsui Chemicals and Showa High Polymer (Japan). Eastman Chemical's Eaststar bio-copolyester is utilized in the examples of the present invention for VCI/tarnish incorporation and/or encapsulation studies. These biodegradable co-polyesters can generically be represented by the following formula:

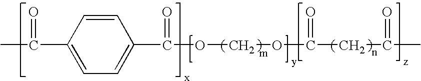

Eastman Chemical produces a polymer representative of this class of biodegradable copolyesters where m and n both equal 4. Such polymers, whose x, y and z values vary, as known to those of skill in the art, are utilized in a number of the examples discussed below.

As noted above, in one embodiment the present invention relates to a biodegradable polyester polymer article (e.g., a biodegradable linear-PCL or star-PCL polymer article) which has been combined with, impregnated with and/or used to encapsulate one or more inhibiting formulas or compounds. Such formulas or compounds include, but are not limited to, corrosion inhibitors, tarnish inhibitors, anti-oxidants and UV-protectants.

Additionally, such articles can further include plasticizers (e.g., dioctyl phthalate, tricrecyl phosphate, etc.) and/or other additives, such as fillers, colorants, slip agents, lubricants and/or tackifiers.

### Corrosion and Tarnish Formulas and Compounds

As noted above, in another embodiment the present invention relates to a biodegradable polyester article which contains therein one or more corrosion and/or tarnish inhibiting formulas or compounds. Any suitable corrosion/tarnish inhibiting formula or compound can be utilized in the present invention. Examples of such formulas and/or compounds are given below. However, it should be noted that the present invention is not limited thereto.

### A. Exemplary Corrosion Inhibiting Formulas

In one embodiment, the present invention relates to a biodegradable polymer with a corrosion inhibiting formula incorporated therein. The corrosion inhibiting formula comprises a mixture of: (1a) at least one volatile corrosion inhibitor (VCI); (1b) at least one anti-oxidant; (1c) at least one alkali or alkaline-earth metal silicate or oxide; and (1d) fumed silica. In another embodiment, the corrosion inhibiting mixture comprises a mixture of: (2a) at least one volatile corrosion inhibitor (VCI); (2b) at least one anti-oxidant; (2c) at least one alkali or alkaline-earth metal silicate or oxide; (2d) fumed silica; and (2e) at least one chemically active compound. In yet another embodiment, the corrosion inhibiting mixture comprises formula which comprises a mixture of: (3a) an inorganic nitrite salt; (3b) a phenol represented by the formula:

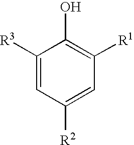

where R¹, R² and R³ are selected from alkyl, aryl, alkenyl, hydroxyalkyl, hydroxyalkenyl and where the sum of carbon atoms in R¹, R² and R³ is in the range of 3 to about 18; and (3c) fumed silica. All of the mixtures described above can further include additional additives.

In one embodiment, the weight ratio of compounds (1a) to (1d), (2a) to (2e) or (3a) to (3c) to biodegradable polymer in the corrosion inhibiting polymer mixture is from about 1:1 to about 1:200, or from about 1:25 to about 1 :150, or even from about 1:50 to about 1:100. In another embodiment, the weight ratio of compounds (1a) to (1d), (2a) to (2e) or (3a) to (3c) to polymer in the corrosion inhibiting polymer mixture is from about 1:1 to about 1:10, or from about 1:1 to about 1:5, or even from about 1:1 to about 1:3.

A biodegradable polymer containing a mixture in accordance with one or more of the above corrosion formulas can be further processed (e.g., by extrusion) to form any desired biodegradable polymer article (e.g., a polymer film) having about 0.5 to about 5 weight percent corrosion inhibiting formula therein. In another embodiment, the amount of corrosion inhibiting formula in the final biodegradable polymer product is about 0.75 to about 4 weight percent.

### 1. Volatile Corrosion Inhibitors

Any suitable volatile corrosion inhibitor (or vapor phase corrosion inhibitor) can be utilized in the at least one corrosion inhibiting formula contained in the present invention. As used herein and in the claims, a VCI is a compound or mixture of compounds with a finite vapor pressure. When placed in an enclosure, a VCI can condense on all surfaces within an enclosure thereby preventing corrosion of any metallic surfaces present in the enclosure.

Some suitable volatile corrosion inhibitors are disclosed in U.S. Pat. Nos. 4,290,912; 5,320,778; and 5,855,975, which are all incorporated herein by reference in their entirety for their teachings of such compounds. For example, useful vapor phase or volatile corrosion inhibitors include, but are not limited to, triazoles and/or inorganic nitrites (e.g., nitrite salts).

In one embodiment, exemplary inorganic nitrite salts include, but are not limited to, metal nitrites such as sodium nitrite, potassium nitrite and barium nitrite. In another embodiment, any suitable Group 1 or Group 2 nitrite (New Notation System) can be used in the at least one corrosion inhibiting formula contained in the present invention.

In another embodiment, the one or more vapor phase or volatile corrosion inhibitors utilized in the present invention can be a triazole. Exemplary triazoles include, but are not limited to, benzotriazole, tolyltriazole and/or sodium tolyltriazole.

In yet another embodiment, the vapor phase or volatile corrosion inhibitor utilized in the present invention can be any suitable mixture of two or more of the above-mentioned inhibitors.

### 2. Anti-Oxidants

Any suitable anti-oxidant can be utilized in the at least one corrosion inhibiting formula contained in the present invention. Exemplary anti-oxidants include, but are not limited to, tri-substituted phenols independently substituted in the 2, 4 and 6 positions with one or more alkyl, hydroxyalkyl, aryl, alkenyl or hydroxyalkenyl groups of the general formula shown below.

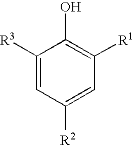

In one embodiment, the sum of the carbon atoms present in the substituent groups R¹, R² and R³ is in the range of 3 to about 36, or even in the range of 3 to about 18.

In another embodiment, a mixture of two or more of the above-mentioned anti-oxidants can be utilized in the at least one corrosion inhibiting formula contained in the present invention.

### 3. Alkali/Alkaline-Earth Metal Silicates/Oxides

Any suitable Group 1 or 2 silicate or oxide can be utilized in the at least one corrosion inhibiting formula contained in the present invention. Exemplary silicates include lithium silicate, sodium silicate, potassium silicate and barium silicate. With regard to the silicates utilized in the at least one corrosion inhibiting formula contained in the present invention, the weight ratio of alkali or alkaline-earth metal oxide to silicate can vary. In one embodiment, this ratio of metal oxide to silicate is from about 5:1 to about 1:5. In another embodiment, the ratio of metal oxide to silicate is from about 3:1 to about 1:3.

In another embodiment, a mixture of one or more silicates can be utilized in the at least one corrosion inhibiting formula contained in the present invention. In yet another embodiment, the one or more silicates can be in a glassy or crystalline state.

In yet another embodiment, at least one alkali or alkaline-earth metal oxide is utilized in the at least one corrosion inhibiting formula contained in the present invention rather than, or in addition to, the one or more silicates discussed above. Exemplary alkali and alkaline-earth metal oxides include, but are not limited to, magnesium oxide, calcium oxide, strontium oxide and barium oxide. In another embodiment, a mixture of two or more alkali or alkaline-earth metal oxides can be utilized in the at least one corrosion inhibiting formula of the present invention.

### 4. Fumed Silica

Any suitable fumed silica can be utilized in the at least one corrosion inhibiting formula contained in the present invention. Suitable fumed silicas are available under the tradenames Cab-O-Sil from Cabot Corporation and Aerosil from American Cyanamid.

### 5. Chemically Active Compound

If present, the at least one chemically active compound utilized in the at least one corrosion inhibiting formula contained in the present invention can be an oxide compound, or combination thereof, which can react with one or more compounds to form compounds which are insoluble in aqueous environments. Exemplary chemically active compounds include, but are not limited to, iron oxides (both ferrous oxide and ferric oxide), cobalt oxide, nickel oxide, copper oxides (both cuprous oxide and cupric oxide) and zinc oxide.

In another embodiment, mixtures of two or more of the above-mentioned oxides can be utilized.

### 6. Additional Additives

In addition to components (1a) to (1d) (or (2a) to (2e)), the at least one corrosion inhibiting formula contained in the present invention can optionally include additional additives such as processing aids, plasticizers (e.g., dioctyl phthalate, tricrecyl -phosphate, etc.) and/or other additives such as fillers, colorants, slip agents, lubricants, tackifiers, UV-protectants, etc.

In one embodiment, the one or more corrosion inhibiting formulas contained in the present invention are acid-free (i.e., the mixtures contain an amount, if any, of acidic compounds which do not adversely affect the final pH of the corrosion inhibiting formulas of the present invention). For example, in one embodiment, acid free can mean having a pH of more than about 5, or more than about 6, or even more than about 7.

In another embodiment, the one or more corrosion inhibiting formulas contained in the present invention optionally contain an odor-suppressing compound. Such compounds include, but are not limited to, iron oxides (both ferrous oxide and ferric oxide), cobalt oxide, nickel oxide, copper oxides (both cuprous oxide and cupric oxide), zinc oxide, magnesium oxide and calcium oxide.

### Examples

The above corrosion inhibiting formulas are further illustrated by the following examples wherein the term “parts” refers to parts by weight unless otherwise indicated. The following examples are not meant to be limiting, rather they are illustrative of only a few embodiments within the scope of the present invention.

Examples A-1, A-3 and A-5 describe the preparation of corrosion inhibiting formulas in a polymer carrier. Examples A-2, A-4 and A-6 describe the general preparation of polymer films utilizing the corrosion inhibiting formulas of Examples A-1, A-3 and A-5, respectively.

### Example A-1

| | |
|---|---|
| Sodium Nitrite | 2.5 parts |
| Sodium Silicate¹ | 0.2 parts |
| “lonol”² | 0.5 parts |
| “Cab-O-Sil”³ | 0.1 parts |
| Biodegradable Polymer PCL⁴ | 7.0 parts |

¹Sodium Silicate is a glassy product with a weight ratio of silica to sodium oxide of 2 (commercially available from the PQ Corporation).
²“lonol” is 2, 6-di-tert-butyl-4-methyl phenol (commercially available from the Uniroyal Chemical Company).
³“Cab-O-Sil” is fumed silica (commercially available from the Cabot Corporation).
⁴Polymer PCL is biodegradable aliphatic polyester polymer. It is fully biodegradable polyester and passes the ASTM and ISO Standards of biodegradability and compostability (commercially available from Dow Chemical Corporation).

The corrosion inhibiting formula contained in the above-mentioned polymer is formed by extruding the above-mentioned mixture above about 200° F. (about 93° C.) using a Werner Pfleiderer ZSK-30 twin-screw extruder with a L/D of 32:1, and a standard strand die for extrusion operations (the same extruder and die combination were utilized for all of Examples A-1 to A-6; B-1; C-1; and D-1 to D-3). The corrosion inhibiting formula according to Example A-1 shows little degradation and demonstrates excellent corrosion-inhibiting properties using test method FTM-101 B (Method 4031).

### Example A-2

This Example describes a volatile corrosion-inhibiting article in the form of an extruded thermoplastic film which is formed by combining the corrosion inhibiting formula of Example A-1 with a suitable amount of polymer. This mixture is then extruded and blown into a film at a temperature above about 250° F. (about 121° C.). The resultant film shows no discoloration or gas formation and possesses excellent corrosion-inhibiting properties when tested against mild steel using test methods FTM-101B (Method 4031) and ASTM D 1735-92.

The film, according to this Example, is formed as noted above by mixing a combination of the following ingredients:

| | |
|---|---|
| The mixture of Example A-1 | 2 parts |
| Linear poly (ε-carpolactone) (PCL) | 98 parts |

### Example A-3

| | |
|---|---|
| Sodium Nitrite | 2.5 parts |
| Sodium Silicate | 0.2 parts |
| “Cobratec TT-85”⁵ | 0.5 parts |
| “lonol” | 0.5 parts |
| “Cab-O-Sil” | 0.1 parts |
| Polymer PCL | 7.0 parts |

⁵“Cobratec TT-85” is sodium tolyltriazole, a corrosion inhibitor commercially available from the Sherwin-Williams Company.

The corrosion inhibiting formula contained in the above-mentioned polymer carrier is formed by extruding the above-mentioned mixture above about 200° F. (about 93° C.). The corrosion inhibiting formula according to Example A-3 shows little degradation and demonstrates excellent corrosion-inhibiting properties using test method FTM-101B (Method 4031).

### Example A-4

This Example describes a volatile corrosion-inhibiting article in the form of an extruded thermoplastic film which is formed by combining the corrosion inhibiting formula of Example A-3 with a suitable amount of polymer. This mixture is then extruded and blown into a film at a temperature above about 250° F. (about 121° C.). The resultant film shows no discoloration or gas formation and possesses excellent corrosion-inhibiting properties when tested against mild steel using test methods FTM-101B (Method 4031) and ASTM D 1735-92.

The film, according to this Example, is formed as noted above by mixing a combination of the following ingredients:

| | |
|---|---|
| The mixture of Example A-3 | 2 parts |
| Polymer PCL | 98 parts |

### Example A-5

| | |
|---|---|
| Sodium Nitrite | 2.5 parts |
| Sodium Silicate | 0.2 parts |
| “lonol” | 0.5 parts |
| “Cobratec TT-85” | 0.5 parts |
| Zinc Oxide | 1.0 parts |
| “Cab-O-Sil” | 0.1 parts |
| Polymer PCL | 7.0 parts |

The corrosion inhibiting formula contained in the above-mentioned polymer carrier is formed by extruding the above-mentioned mixture above about 200° F. (about 93° C.). The corrosion inhibiting formula according to Example A-5 shows little degradation and demonstrates excellent corrosion-inhibiting properties using test method FTM-101B (Method 4031).

### Example A-6

This Example describes a volatile corrosion-inhibiting article in the form of an extruded thermoplastic film which is formed by combining the corrosion inhibiting formula of Example A-5 with a suitable amount of polymer. This mixture is then extruded and blown into a film at a temperature above about 250° F. (about 121° C.). The resultant film shows no discoloration or gas formation and possesses excellent corrosion-inhibiting properties when tested against mild steel and non-ferrous metals such as copper, brass and aluminum using test methods FTM-101B (Method 4031) and ASTM D 1735-92.

The film, according to this Example, is formed as noted above by mixing a combination of the following ingredients:

| | |
|---|---|
| The mixture of Example A-5 | 3 parts |
| Polymer PCL | 97 parts |

### B. Exemplary Tarnish Inhibiting Formulas

As noted above, in one embodiment the present invention relates to biodegradable polymer mixtures which contain therein at least one tarnish inhibiting formula which comprises a mixture of: (4a) at least one strong alkali compound; and (4b) at least one compound which yields an insoluble sulfide. This mixture can further include one or more additional additives such as anti-oxidants, corrosion inhibitors, etc.

In one embodiment, the weight ratio of compounds (4a) and (4b) to the polymer in the tarnish inhibiting polymer mixture is from about 1:1 to about 1:100, or from about 1:10 to about 1:80, or even from about 1:20 to about 1:60. In another embodiment, the weight ratio of compounds (4a) and (4b) to the polymer in the tarnish inhibiting polymer mixture is from about 1:1 to about 1:10, or from about 1:2 to about 1:8, or even from about 1:3 to about 1:7.

A mixture in accordance with the above can be further processed (e.g., by extrusion) to form any desired biodegradable polymer article (e.g., a polymer film) having about 0.5 to about 5 weight percent tarnish inhibiting formula therein. In another embodiment, the amount of tarnish inhibiting formula in the final biodegradable polymer product is about 0.75 to about 4 weight percent.

### 1. Strong Alkali Compound

Any suitable Group 1 or 2 silicate or oxide can be utilized in the at least one tarnish inhibiting formula contained in the present invention as component (4a), the at least one strong alkali compound. Exemplary silicates include lithium silicate, sodium silicate, potassium silicate and barium silicate. With regard to the silicates utilized in the present invention, the weight ratio of alkali or alkaline-earth metal oxide to silicate can vary. In one embodiment, this ratio of metal oxide to silicate is from about 5:1 to about 1:5. In another embodiment, the ratio of metal oxide to silicate is from about 2.5:1 to about 1:2.5.

In another embodiment, a mixture of one or more silicates can be used in the at least one tarnish inhibiting formula contained in the present invention. In yet another embodiment, the one or more silicates can be in a glassy or crystalline state.

In yet another embodiment, at least one alkali or alkaline-earth metal oxide is utilized in the at least one tarnish inhibiting formula contained in the present invention rather than the one or more silicate. Exemplary alkaline-earth metal oxides include, but are not limited to, magnesium oxide, calcium oxide, strontium oxide and barium oxide. In another embodiment, a mixture of two or more alkali or alkaline-earth metal oxides can be utilized in the at least one tarnish inhibiting formula contained in the present invention.

While not wishing to be bound to any one theory, it is believed that the one or more strong alkali compounds react with any hydrogen sulfide (H₂S) and/or any acid/acidic compounds present in the environment. This prevents such compounds and/or acids from passing through the polymer matrix of a polymer article which optionally contains therein a tarnish inhibiting formula according to the present invention.

### 2. Compounds Which Yield Insoluble Compounds

Any suitable compound which forms an insoluble compound such as a sulfide (solubility of less than about 0.1 grams/liter of water) when H₂S is present can be utilized in the at least one tarnish inhibiting formula contained in the present invention as component (4b), the compound which yields an insoluble sulfide. Exemplary compounds include, but are not limited to, compounds containing iron, cobalt, nickel, copper and zinc. Mixtures of two or more such compounds can also be utilized in the at least one tarnish inhibiting formula contained in the present invention. Suitable anions for the compound according to component (4b) include oxides and hydroxides.

Exemplary compounds include, but are not limited to, zinc oxide, zinc hydroxide, iron oxides (both ferrous oxide and ferric oxide), iron hydroxide (Fe(OH)₂), cobalt oxide, cobalt hydroxides (both Co(OH)₂ and Co₂O₃.3H₂O), nickel oxide, nickel (II) hydroxide, copper oxides (both cuprous oxide and cupric oxide) and copper hydroxide. Mixtures of two or more of the above compounds can also be utilized as component (4b).

### 3. Volatile Corrosion Inhibitors

In one embodiment, the tarnish inhibiting formula contained in the present invention further includes any suitable volatile corrosion inhibitor (or vapor phase corrosion inhibitor). Some suitable volatile corrosion inhibitors are disclosed in U.S. Pat. Nos. 4,290,912; 5,320,778; and 5,855,975, which are all incorporated herein by reference in their entirety for their teachings of such compounds. For example, useful vapor phase or volatile corrosion inhibitors include, but are not limited to, triazoles and/or inorganic nitrites (e.g., nitrite salts).

Exemplary inorganic nitrite salts include, but are not limited to, metal nitrites such as sodium nitrite, potassium nitrite and barium nitrite. In another embodiment, any suitable Group 1 or Group 2 nitrite (New Notation System) can be used in the one or more tarnish inhibiting formulas contained in the present invention.

In another embodiment, if present, the one or more tarnish inhibiting formulas contained in the present invention can optionally include one or more vapor phase or volatile corrosion inhibitors selected from triazoles. Exemplary triazoles include, but are not limited to, benzotriazole, tolyltriazole and/or sodium tolyltriazole.

In yet another embodiment, the optional vapor phase or volatile corrosion inhibitor utilized in the present invention can be any suitable mixture of two or more of the above-mentioned volatile corrosion inhibitors.

### 4. Anti-Oxidants

If desired, any suitable anti-oxidant can be utilized in the tarnish inhibiting portion of the present invention. Exemplary anti-oxidants include, but are not limited to, tri-substituted phenols substituted in the 2, 4 and 6 positions with one or more alkyl, hydroxyalkyl, aryl, alkenyl or hydroxyalkenyl groups of the general formula shown below.

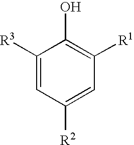

In one embodiment, the sum of the carbon atoms present in the substituent groups R¹, R² and R³ is in the range of 3 to about 36, or even in the range of 3 to about 18.

In another embodiment, a mixture of two or more of the above-mentioned anti-oxidants can be utilized in the tarnish inhibiting portion of the present invention.

### 5. Additional Additives

In addition to components (4a) and (4b), the tarnish inhibiting formulas optionally contained in the present invention may also include processing aids such as plasticizers (e.g., dioctyl phthalate, tricrecyl phosphate, etc.) and/or other additives such as fillers, colorants, slip agents, lubricants, tackifiers, UV-protectants, etc.

In one embodiment, the one or more corrosion inhibiting formulas contained in the present invention are acid-free (i.e., the mixtures contain an amount, if any, of acidic compounds which do not adversely affect the final pH of the corrosion inhibiting formulas of the present invention). For example, in one embodiment, acid free can mean having a pH of more than about 5, or more than about 6, or even more than about 7.

In another embodiment, a tarnish inhibiting formula according to the present invention optionally contains an odor-suppressing compound. Such compounds include, but are not limited to, iron oxides (both ferrous oxide and ferric oxide), cobalt oxide, nickel oxide, copper oxides (both cuprous oxide and cupric oxide), zinc oxide, magnesium oxide and calcium oxide.

### 6. Examples

### Example B-1

(a) The following compounds are mixed to form a tarnish inhibiting mixture including therein a tarnish inhibiting formula.

| | |
|---|---|
| Sodium Silicate | 25 parts |
| Zinc Oxide | 25 parts |
| Polymer PCL | 50 parts |

The concentrate formed by extruding the mixture above about 200° F. (about 93° C.) shows little degradation.

(b) Four different films which contain the above tarnish inhibiting mixtures are formed by uniformly mixing the following ingredients.

| Ingredients | Film 1 | Film 2 | Film 3 | Film 4 |
|---|---|---|---|---|
| Tarnish | 2 parts | 3 parts | 4 parts | 5 parts |
| Inhibiting | | | | |
| Mixture of | | | | |
| Example B-1 | | | | |
| Polymer PCL | 98 parts | 97 parts | 96 parts | 95 parts |

The mixtures are extruded and blown into films at a temperature of at least about 250° F. (about 121° C.). The resultant films show no discoloration or gas formation. The films are tested using the following method.

Silver coupons are sealed in a bag made of each of the above Films 1 to 4. The test bags made of Films 1 to 4 are then exposed in a container to an environment containing H₂S and 100% humidity. A control is also utilized. The control is a bag made of plain polyethylene with the same thickness as Films 1 to 4. The silver coupons sealed in the bag made of plain polyethylene with the same thickness are exposed to the same container in order to serve as a control. The coupons are subjected to this environment for at least about 4 hours.

It should be noted that prior to beginning the test procedure, the silver coupons must be clean, free of tarnish and other deposits.

The results of each of the films are judged by the final state of the coupons that are contained therein. First, the coupons are checked by the “naked” eye for any visible tarnishing. Next, the coupons are checked by the “naked” eye for any other corrosive effects such as mottling or discoloration of one or more surfaces of the coupons.

Based on the above test, the films with at least a 2% concentration of the above-mentioned tarnish inhibiting mixture are found to possess excellent anti-tarnish properties.

### C. Other Inhibiting Formulas and Compounds

In yet another embodiment, the present invention relates to biodegradable polymer mixtures which contain therein at least one corrosion inhibiting formula which comprises a mixture of: (3a) an inorganic nitrite salt, (3b) a trisubstituted phenol and (3c) fumed silica.

The useful inorganic nitrite salts include metal nitrites (such as Group I and 11 metal nitrites) including potassium nitrite, sodium nitrite and calcium nitrite. In one embodiment, the nitrite salt is sodium nitrite.

The trisubstituted phenols which are useful are substituted in the 2, 4 and 6 positions with alkyl, hydroxyalkyl, aryl, alkenyl or hydroxyalkenyl. In one embodiment, the phenol is 2,6 di-t-butyl-4-methyl phenol.

Any suitable fumed silica can be utilized. An exemplary fumed silica is available commercially under the tradename “Cab-O-Sil” from the Cabot Corporation.

This corrosion inhibiting formula is further illustrated by means of the following example wherein the term “parts” refers to parts by weight unless otherwise indicated.

### Example C-1

| | |
|---|---|
| Sodium Nitrite | 3 parts |
| “lonol” | 2 parts |
| “Cab-O-Sil” | 0.1 parts |
| Oleyl Alcohol | 3 parts |
| Polymer PCL | 8 parts |

This mixture is formed by heating the mixture shown in Example C-1 at 250° F. (about 121° C.) for 30 minutes. The mixture shows little degradation and demonstrates excellent volatile corrosion inhibiting properties using test method FTM-101B Method 4031.

In yet another embodiment, the present invention relates to biodegradable polymer mixtures which contain therein at least one inhibiting formula or compound. Any inhibiting compound can be utilized which provides at least one of the following properties/functions: corrosion inhibition, tarnish inhibition, anti-oxidant and/or UV-protectant.

### D. Biodegradable Film Examples

The present invention is further illustrated by the following examples wherein the term “parts” refers to parts by weight unless otherwise indicated. The following examples are not meant to be limiting, rather they are illustrative of only a few embodiments within the scope of the present invention.

### Example D-1

Approximately 345.2 gm of VCI having a formula according to that disclosed in U.S. Pat. No. 4,290,912 and 808.7 gm of linear PCL are mixed in a blender for 15 minutes. This mixture is then fed to a twin-screw co-rotating extruder (L/D=30) using a twin-screw feeder operating at 703 rpm (revolutions per minute). The operating feed rate is set to 7.6 lb/hr. The reaction is carried out under an inert atmosphere of nitrogen. The following conditions are utilized in the extruder.

Temperature Profile in Extruder - Example D-1

| | | | | | | | Die |
|---|---|---|---|---|---|---|---|
| | Zone 1 | Zone 2 | Zone 3 | Zone 4 | Zone 5 | Zone 6 | Temp. |
| Set Temperature (° C.) | 40 | 130 | 140 | 145 | 150 | 150 | |
| Actual Temperature (° C.) | 56 | 131 | 143 | 183 | 149 | 149 | 201 |

The percent torque is set to 35 and the screw rpm to 151.

The screw configuration utilized in the present invention, along with the pressure profile observed, are shown in FIGS. 1 and 2, respectively. The screw configuration comprises both conveying and kneading blocks. With regard to the numbers and alphabetical characters shown in FIG. 1, the numbers and alphabetical characters are descriptors of the screw elements. The alphabetical notations LH stands for left-handed, RH stands for right-handed and KB stands for kneading block. Where no alphabetical indication is given, is known in the art that right-handed elements are being utilized.

With regard to the numerical notations in FIG. 1, conveying screw elements are described by two numbers. The first number listed is the “pitch” of the screw element. The second number listed is the “length” of the screw element. The numbers contained in parenthesis in FIG. 1 denote the number of times the same screw element is repeated. Numbers in parenthesis are used rather then repeating identical screw elements multiple times in FIG. 1 in order to reduce the length of FIG. 1.

For example, the first conveying element from the left in FIG. 1 is listed as 42/42 (4). This translates as a screw element with a “pitch” of 42 and a “length” of 42, with four identical screw elements of this kind being placed together.

Kneading screw elements are described by three numbers. The first number is the “angle” of the screw element. The second number is the number of “loaves” on the screw element. The third number is the “length” of the screw element. The numbers contained in parenthesis in FIG. 1 denote the number of times the same screw element is repeated. Numbers in parenthesis are used rather then repeating identical screw elements multiple times in FIG. 1 in order to reduce the length of FIG. 1.

For example, the first kneading element from the left in FIG. 1 is listed as 40/5/14 (3). This translates as screw element which has an “angle” of 40, 5 loaves thereon, and a “length” of 14, with three identical screw elements of this kind being placed together.

The vent port on the extruder is closed to prevent out flow of material and homogeneous strands of material are obtained. These strands are then quenched in a water bath and air-dried before being palletized on line. The final material proves to be well mixed and did not pose any feeding issues. It is easily subjected to further processing. The strands produced in accordance with the above example are homogeneous and yellow in appearance.

### Example D-2

Approximately 503 gm each of VCI (also having a formula according to U.S. Pat. No. 4,290,912) and linear PCL are mixed in a blender for 15 minutes. This mixture is then fed to a twin-screw co-rotating extruder (L/D=30) using a twin-screw feeder operating at 703 rpm. The operating feed rate is set to be 7.6 lb/hr. The reaction is carried out under an inert atmosphere of nitrogen. The following conditions are utilized in the extruder.

Temperature Profile in Extruder - Example D-2

| | | | | | | | Die |
|---|---|---|---|---|---|---|---|
| | Zone 1 | Zone 2 | Zone 3 | Zone 4 | Zone 5 | Zone 6 | Temp. |
| Set Temperature (° C.) | 40 | 130 | 140 | 145 | 150 | 150 | |
| Actual Temperature (° C.) | 55 | 130 | 139 | 187 | 154 | 150 | 201 |

The percent torque is set to 30 and the screw rpm to 151.

The screw configuration utilized in the present invention, along with the pressure profile observed, are shown in FIGS. 1 and 2, respectively. The screw configuration comprises both conveying and kneading blocks.

The vent port on the extruder is closed to prevent out flow of material and homogeneous strands of material are obtained. These strands are then quenched in a water bath and air-dried before being palletized on line. The final material proves to be well mixed and did not pose any feeding issues. It is easily subjected to further processing. The strands produced in accordance with the above example are homogeneous and yellow in appearance. Additionally, the strand of Example D-2 is thinner than those produced in accordance with Example D-1, and the torque for this example is set lower than that of Example D-1 to enable operation at higher throughputs.

### Example D-3

Based on the above examples with the polycaprolactone masterbatch preparation, it is possible to produce a biodegradable polymer mixture having a load level of 50% VCI material in a biodegradable polyester. This mixture, commonly referred to as a “masterbatch” can be further processed, as noted below, to produce any desired biodegradable polymer containing therein VCI material.

The following resin formulations are prepared so as to contain 1% VCI loadings (let down of the 50% VCI loaded masterbatch to 1% VCI) for preparation of blown or extruded films. The ratios below are given in terms of weight.

### Masterbatches

M-1) Linear PCL polymer to VCI (70:30), VCI formulation per U.S. Pat. No. 4,290,912

M-2) Linear PCL polymer to VCI (50:50), VCI formulation per U.S. Pat. No. 4,290,912

M-3) Eastman Co-Polyester (EPE) to VCI (50:50), VCI formulation per U.S. Pat. No.4,290,912

M-4) Branched polyester polymer (as disclosed in U.S. Pat. Nos. 5,500,465; 5,801,224; 5,906,783; and/or 5,969,089) to VCI (50:50), VCI formulation per U.S. Pat. No. 4,290,912

M-5) Linear PCL polymer to VCI (50:50), the VCI formulation is at least one formula according to formulas (1), (2), (3) and/or (4), as discussed above

M-6) Branched polyester polymer (as disclosed in U.S. Pat. Nos. 5,500,465; 5,801,224; 5,906,783; and/or 5,969,089) to VCI (50:50), the VCI formulation is at least one formula according to formulas (1), (2), (3) and/or (4), as discussed above

### Exemplary Film Formulations Using the Above Masterbatches

The above masterbatches are let down as follows. Again the ratios are given in terms of weight:

E-1) Linear PCL to Masterbatch M-2 (98:2)

E-2) EPE to Masterbatch M-2 (98:2)

E-3) Reaction Extruded PCL and Starch to Masterbatch M-2 (98:2)

E-4) Reaction Extruded PCL to Masterbatch M-2 (98:2)

E-5) Reaction Extruded PCL and Starch to Masterbatch M-3 (98:2)

E-6) Reaction Extruded PCL to Masterbatch M-4 (98:2)

E-7) EPE to Masterbatch M-4 (98:2)

### Specific Examples of Film Formulations

### Film Example E-3

This example is a combination of reaction extruded PCL plus starch and Masterbatch M-2 at a weight ratio of 98 parts PCL to 2 parts Masterbatch. This film is extruded is the screw shown in FIG. 1 with the following conditions:

| Zone 1 | 300° F. (about 149° C.) |
|---|---|
| Zone 2 | 320° F. (about 160° C.) |
| Zone 3 | 320° F. (about 160° C.) |
| Clamp Ring | 320° F. (about 160° C.) |
| Adapter | 320° F. (about 160° C.) |
| Die 1 (Lower Die) | 265° F. (about 129° C.) |
| Die 2 (Upper Die) | 265° F. (about 129° C.) |
| Melt Temp. | 325° F. (about 163° C.) |
| Screw Speed | 9.7 rpm |
| Line Speed | 5.1 fpm (feet per minute) |
| Thickness | 1.5 mil |
| Die Diameter | 2 in. |
| Film Diameter | 5.25 in |
| Blown up ratio | 2.63 |

It is relatively easy to blow this film.

### Film Example E-4

This example is a combination of reaction extruded PCL and Masterbatch M-2 at a weight ratio of 98 parts PCL to 2 parts Masterbatch. This film is extruded is the screw shown in FIG. 1 with the following conditions:

| Zone 1 | 235° F. (about 113° C.) |
|---|---|
| Zone 2 | 270° F. (about 132° C.) |
| Zone 3 | 310° F. (about 154° C.) |
| Clamp Ring | 310° F. (about 154° C.) |
| Adapter | 310° F. (about 154° C.) |
| Die 1 (Lower Die) | 280° F. (about 138° C.) |
| Die 2 (Upper Die) | 280° F. (about 138° C.) |
| Melt Temp. | 320° F. (about 160° C.) |
| Screw Speed | 10.5 rpm |
| Line Speed | 5.3 fpm |
| Thickness | 0.9 mil |
| Die Diameter | 2 in. |
| Film Diameter | 5.25 in |
| Blown up ratio | 2.65 |

Initially, it takes about 10 minutes for the bubble to stabilize.

### Film Example E-6

This example is a combination of reaction extruded PCL and Masterbatch M-4 at a weight ratio of 98 parts PCL to 2 parts Masterbatch. This film is extruded is the screw shown in FIG. 1 with the following conditions:

| Zone 1 | 235° F. (about 113° C.) |
|---|---|
| Zone 2 | 270° F. (about 132° C.) |
| Zone 3 | 310° F. (about 154° C.) |
| Clamp Ring | 310° F. (about 154° C.) |
| Adapter | 310° F. (about 154° C.) |
| Die 1 (Lower Die) | 310° F. (about 154° C.) |
| Die 2 (Upper Die) | 310° F. (about 154° C.) |
| Melt Temp. | 320° F. (about 160° C.) |
| Screw Speed | 10.2 rpm |
| Line Speed | 6.8 fpm |
| Thickness | 0.8 mil |
| Die Diameter | 2 in. |
| Film Diameter | 5.875 in (5⅞ in) |
| Blown up ratio | 2.94 |

Initially, it takes about 15 to 20 minutes for the bubble to stabilize. The processing conditions are lower than 100% Star-PCL (Tm ˜395 OF (about 202° C.)).

### Film Example E-7

This example is a combination of Eastman polyester and Masterbatch M-4 at a weight ratio of 98 parts PCL to 2 parts Masterbatch. This film is extruded is the screw shown in FIG. 1 with the following conditions:

| Zone 1 | 245° F. (about 118° C.) |
|---|---|
| Zone 2 | 255° F. (about 124° C.) |
| Zone 3 | 260° F. (about 127° C.) |
| Clamp Ring | 260° F. (about 127° C.) |
| Adapter | 260° F. (about 127° C.) |
| Die 1 (Lower Die) | 245° F. (about 118° C.) |
| Die 2 (Upper Die) | 245° F. (about 118° C.) |
| Melt Temp. | 265° F. (about 129° C.) |
| Screw Speed | 17.9 rpm |
| Line Speed | 7.7 fpm |
| Thickness | 1.0 mil |
| Die Diameter | 2 in. |
| Film Diameter | 6.375 in (6⅜ in) |
| Blown up ratio | 3.2 |

It is easy to stabilize the bubble in this example. However, care should be taken when increasing the bubble size. The size of the bubble must be increased slowly. Once the bubble is stabilized, the process runs very well. The processing conditions are lower than 100% Eastman polyester (Tm ˜110° F. (about 43° C.)). Additionally, chilled air is needed to cool the bubble prior to collapsing same.

Although the present invention has been shown and described with respect to certain embodiments, it is obvious that equivalent alterations and modifications will occur to others skilled in the art upon the reading and understanding of this specification. In particular with regard to the various functions performed by the above described components, the terms (including any reference to a “means”) used to describe such components are intended to correspond, unless otherwise indicated, to any component which performs the specified function of the described component (e.g., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more other features of the other embodiments as may be desired and advantageous for any given or particular application.

What is claimed is:

1. A biodegradable polymer article comprising a biodegradable polyester and at least one formula selected from:
(1) a formula which comprises:
(1a) at least one volatile corrosion inhibitor;
(1b) at least one anti-oxidant;
(1c) at least one alkali or alkaline-earth metal silicate or oxide; and
(1d) fumed silica,
(2) a formula which comprises:
(2a) at least one volatile corrosion inhibitor;
(2b) at least one anti-oxidant;
(2c) at least one alkali or alkaline-earth metal silicate or oxide;
(2d) fumed silica; and
(2e) at least one chemically active compound,
(3) a formula which comprises:
(3a) an inorganic nitrite salt;
(3b) a phenol represented by the formula: 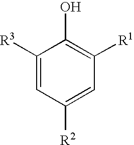
where R¹, R² and R³ are each independently selected from alkyl, aryl, alkenyl, hydroxyalkyl and hydroxyalkenyl, and where the sum of carbon atoms in R¹, R² and R³ is in the range of 3 to about 18; and
(3c) fumed silica, or
(4) a formula which comprises:
(4a) at least one strong alkali compound; and
(4b) at least one compound which yields an insoluble compound.

2. The biodegradable polymer article of claim 1, wherein components (1a) and (2a) are each independently selected from an inorganic nitrite salt, triazole compound and mixtures of two or more thereof.

3. The biodegradable polymer article of claim 2, wherein components (1a) and (2a) are each independently selected from sodium nitrite, potassium nitrite, barium nitrite and mixtures of two or more thereof.

4. The biodegradable polymer article of claim 2, wherein components (1a) and (2a) are independently selected from benzotriazole, tolyltriazole, sodium tolyltriazole and mixtures of two or more thereof.

5. The biodegradable polymer article of claim 1, wherein component (1b) and (2b) are each independently a tri-substituted phenol independently substituted in the 2, 4 and 6 positions with one or more alkyl, hydroxyalkyl, aryl, alkenyl or hydroxyalkenyl groups represented by the general formula: 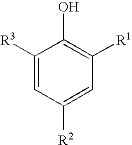
wherein the sum of the carbon atoms present in the substituent groups R¹, R² and R³ is in the range of 3 to about 36.

6. The biodegradable polymer article of claim 5, wherein component (1b) and (2b) are each independently a tri-substituted phenol independently substituted in the 2, 4 and 6 positions with one or more alkyl, hydroxyalkyl, aryl, alkenyl or hydroxyalkenyl groups represented by the general formula: 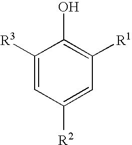
wherein the sum of the carbon atoms present in the substituent groups R¹, R² and R³ is in the range of 3 to about 18.

7. The biodegradable polymer article of claim 1, wherein component (1c) and (2c) are each independently selected from lithium silicate, sodium silicate, potassium silicate, barium silicate and mixtures of two or more thereof.

8. The biodegradable polymer article of claim 1, wherein component (1c) and (2c) are each independently selected from magnesium oxide, calcium oxide, strontium oxide, barium oxide and mixtures of two or more thereof.

9. The biodegradable polymer article of claim 1, wherein component (1c) and (2c) each independently contain one or more compounds selected from: (A) at least one silicate compound selected from lithium silicate, sodium silicate, potassium silicate and barium silicate, in combination with one or more compounds selected from: (B) at least one oxide compound selected from magnesium oxide, calcium oxide, strontium oxide and barium oxide.

10. The biodegradable polymer article of claim 1, wherein component (4a) is selected from at least one Group 1 silicate, Group 1 oxide, Group 2 silicate, Group 2 oxide and mixtures of two or more thereof.

11. The biodegradable polymer article of claim 10, wherein the Group 1 or Group 2 silicates and Group 1 or Group 2 oxides are selected from lithium silicate, sodium silicate, potassium silicate, barium silicate, magnesium oxide, calcium oxide, strontium oxide, barium oxide and mixtures of two or more thereof.

12. The biodegradable polymer article of claim 1, wherein component (4b) is selected from one or more of zinc oxide, zinc hydroxide, iron oxides, iron hydroxide, cobalt oxide, cobalt hydroxides, nickel oxide, nickel (II) hydroxide, copper oxides, copper hydroxide and mixtures of two or more thereof.

13. The biodegradable polymer article of claim 1, wherein formula (4) further comprising at least one vapor phase or volatile corrosion inhibitor.

14. The biodegradable polymer article of claim 13, wherein the vapor phase or volatile corrosion inhibitor is selected from inorganic nitrite salts, triazole compounds and mixtures of two or more thereof.

15. The biodegradable polymer article of claim 14, wherein the vapor phase or volatile corrosion inhibitor is selected from sodium nitrite, potassium nitrite, barium nitrite and mixtures of two or more thereof.

16. The biodegradable polymer article of claim 14, wherein the at least one vapor phase or volatile corrosion inhibitor is selected from benzotriazole, tolyltriazole, sodium tolyltriazole and mixtures of two or more thereof.

17. The biodegradable polymer article of claim 1, wherein the biodegradable polymer is selected from linear poly ε-carpolactone, star poly ε-carpolactone and biodegradable aliphatic-aromatic copolyesters.

18. The biodegradable polymer article of claim 1, further comprising at least one plasticizer, filler, colorant, slip agent, lubricant, tackifier, anti-oxidant, UV-protectant, and mixtures of two or more thereof.

19. A biodegradable polymer article comprising a biodegradable polyester and at least one formula selected from:
(1) a formula which comprises:
(1a) at least one volatile corrosion inhibitor;
(1b) at least one anti-oxidant;
(1c) at least one alkali or alkaline-earth metal silicate or oxide; and
(1d) fumed silica,
(2) a formula which comprises:
(2a) at least one volatile corrosion inhibitor;
(2b) at least one anti-oxidant;
(2c) at least one alkali or alkaline-earth metal silicate or oxide;
(2d) fumed silica; and
(2e) at least one chemically active compound,
(3) a formula which comprises:
(3a) an inorganic nitrite salt;
(3b) a phenol represented by the formula: 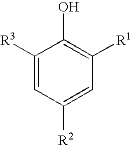
where R¹, R² and R³ are each independently selected from alkyl, aryl, alkenyl, hydroxyalkyl and hydroxyalkenyl, and where the sum of carbon atoms in R¹, R² and R³ is in the range of 3 to about 18; and
(3c) fumed silica, or
(4) a formula which comprises:
(4a) at least one strong alkali compound; and
(4b) at least one compound which yields an insoluble compound,
wherein the at least one formula is present in an amount in the range of about 0.5 to about 5 percent by weight.

20. The biodegradable polymer article of claim 19, wherein components (1a) and (2a) are each independently selected from an inorganic nitrite salt, triazole compound and mixtures of two or more thereof.

21. The biodegradable polymer article of claim 20, wherein components (1a) and (2a) are each independently selected from sodium nitrite, potassium nitrite, barium nitrite and mixtures of two or more thereof.

22. The biodegradable polymer article of claim 20, wherein components (1a) and (2a) are independently selected from benzotriazole, tolyltriazole, sodium tolyltriazole and mixtures of two or more thereof.

23. The biodegradable polymer article of claim 19, wherein component (1b) and (2b) are each independently a tri-substituted phenol independently substituted in the 2, 4 and 6 positions with one or more alkyl, hydroxyalkyl, aryl, alkenyl or hydroxyalkenyl groups represented by the general formula: 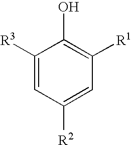
wherein the sum of the carbon atoms present in the substituent groups R¹, R² and R³ is in the range of 3 to about 36.

24. The biodegradable polymer article of claim 23, wherein component (1b) and (2b) are each independently a tri-substituted phenol substituted in the 2, 4 and 6 positions with one or more alkyl, hydroxyalkyl, aryl, alkenyl or hydroxyalkenyl groups represented by the general formula: 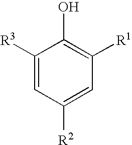
wherein the sum of the carbon atoms present in the substituent groups R¹, R² and R³ is in the range of 3 to about 18.

25. The biodegradable polymer article of claim 19, wherein component (1c) and (2c) are each independently selected from lithium silicate, sodium silicate, potassium silicate, barium silicate and mixtures of two or more thereof.

26. The biodegradable polymer article of claim 19, wherein component (1c) and (2c) are each independently selected from magnesium oxide, calcium oxide, strontium oxide, barium oxide and mixtures of two or more thereof.

27. The biodegradable polymer article of claim 19, wherein component (1c) and (2c) each independently contain one or more compounds selected from: (A) at least one silicate compound selected from lithium silicate, sodium silicate, potassium silicate and barium silicate, in combination with one or more compounds selected from: (B) at least one oxide compound selected from magnesium oxide, calcium oxide, strontium oxide and barium oxide.

28. The biodegradable polymer article of claim 19, wherein component (4a) is selected from at least one Group 1 silicate, Group 1 oxide, Group 2 silicate, Group 2 oxide and mixtures of two or more thereof.

29. The biodegradable polymer article of claim 28, wherein the Group 1 or Group 2 silicates and Group 1 or Group 2 oxides are selected from lithium silicate, sodium silicate, potassium silicate, barium silicate, magnesium oxide, calcium oxide, strontium oxide, barium oxide and mixtures of two or more thereof.

30. The biodegradable polymer article of claim 19, wherein component (4b) is selected from one or more of zinc oxide, zinc hydroxide, iron oxides, iron hydroxide, cobalt oxide, cobalt hydroxides, nickel oxide, nickel (II) hydroxide, copper oxides, copper hydroxide and mixtures of two or more thereof.

31. The biodegradable polymer article of claim 19, wherein formula (4) further comprising at least one vapor phase or volatile corrosion inhibitor.

32. The biodegradable polymer article of claim 31, wherein the vapor phase or volatile corrosion inhibitor is selected from inorganic nitrite salts, triazole compounds and mixtures of two or more thereof.

33. The biodegradable polymer article of claim 32, wherein the vapor phase or volatile corrosion inhibitor is selected from sodium nitrite, potassium nitrite, barium nitrite and mixtures of two or more thereof.

34. The biodegradable polymer article of claim 32, wherein the at least one vapor phase or volatile corrosion inhibitor is selected from benzotriazole, tolyltriazole, sodium tolyltriazole and mixtures of two or more thereof.

35. The biodegradable polymer article of claim 19, wherein the biodegradable polymer is selected from linear poly c-carpolactone, star poly F-carpolactone and biodegradable aliphatic-aromatic copolyesters.

36. The biodegradable polymer article of claim 19, further comprising at least one plasticizer, filler, colorant, slip agent, lubricant, tackifier, anti-oxidant, UV-protectant, and mixtures of two or more thereof.

37. A biodegradable polymer article comprising a biodegradable polyester or copolyester and at least one formula selected from:
(1) a formula which comprises:
(1a) at least one volatile corrosion inhibitor;
(1b) at least one anti-oxidant;
(1c) at least one alkali or alkaline-earth metal silicate or oxide; and
(1d) fumed silica,
(2) a formula which comprises:
(2a) at least one volatile corrosion inhibitor;
(2b) at least one anti-oxidant;
(2c) at least one alkali or alkaline-earth metal silicate or oxide;
(2d) fumed silica; and
(2e) at least one chemically active compound,
(3) a formula which comprises:
(3a) an inorganic nitrite salt;
(3b) a phenol represented by the formula: 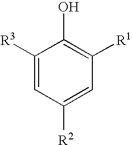
where R¹, R² and R³ are each independently selected from alkyl, aryl, alkenyl, hydroxyalkyl and hydroxyalkenyl, and where the sum of carbon atoms in R¹, R² and R³ is in the range of 3 to about 18; and
(3c) fumed silica, or
(4) a formula which comprises:
(4a) at least one strong alkali compound; and
(4b) at least one compound which yields an insoluble compound,
wherein the at least one formula is present in an amount in the range of about 20 to about 80 percent by weight.

38. The biodegradable polymer article of claim 37, wherein the at least one formula is present in an amount in the range of about 30 to about 60 percent by weight.

39. The biodegradable polymer article of claim 37, wherein the at least one formula is present in an amount in the range of about 30 to about 50 percent by weight.

40. A method for producing a biodegradable polymer film containing at least one inhibiting formula comprising the steps of:
(A) combining at least one inhibiting formula with a biodegradable polyester or copolyester polymer to form a mixture; and
(B) extruding the mixture in an extruder to form a biodegradable polymer film,
wherein the inhibiting formula is selected from:
(1) a formula which comprises:
(1a) at least one volatile corrosion inhibitor;
(1b) at least one anti-oxidant;
(1c) at least one alkali or alkaline-earth metal silicate or oxide; and
(1d) fumed silica,
(2) a formula which comprises:
(2a) at least one volatile corrosion inhibitor;
(2b) at least one anti-oxidant;
(2c) at least one alkali or alkaline-earth metal silicate or oxide;
(2d) fumed silica; and
(2e) at least one chemically active compound,
(3) a formula which comprises:
(3a) an inorganic nitrite salt;
(3b) a phenol represented by the formula: 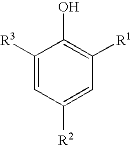
where R¹, R² and R³ are each independently selected from alkyl, aryl, alkenyl, hydroxyalkyl and hydroxyalkenyl, and where the sum of carbon atoms in R¹, R² and R³ is in the range of 3 to about 18; and
(3c) fumed silica, or
(4) a formula which comprises:
(4a) at least one strong alkali compound; and
(4b) at least one compound which yields an insoluble compound.

41. The method of claim 40, wherein the biodegradable polymer is selected from linear poly ε-carpolactone, star poly ε-carpolactone and biodegradable aliphatic-aromatic copolyesters.

42. The method of claim 40, wherein the amount of the at least one inhibiting formula is in the range of about 0.5 to about 5 percent by weight.

43. A biodegradable polymer article comprising a biodegradable polymer selected from linear poly (ε-caprolactone), star poly (ε-caprolactone), aliphatic-aromatic copolyesters and reaction extruded poly (ε-caprolactone) and at least one inhibiting formula selected from corrosion inhibitors, tarnish inhibitors, UV-protectants and mixtures of two or more thereof.

44. The biodegradable polymer article of claim 43, further comprising at least one plasticizer, filler, colorant, slip agent, lubricant, tackifier and mixtures of two or more thereof.

45. A method for producing a biodegradable polymer film containing at least one inhibiting formula comprising the steps of:
(A) combining at least one inhibiting formula with a biodegradable monomer and a catalyst to form a mixture;
(B) processing the mixture of step (A) to form a biodegradable polymer; and
(C) extruding the mixture in an extruder to form a biodegradable polymer film,
wherein the inhibiting formula is selected from:
(1) a formula which comprises:
(1a) at least one volatile corrosion inhibitor;
(1b) at least one anti-oxidant;
(1c) at least one alkali or alkaline-earth metal silicate or oxide; and
(1d) fumed silica,
(2) a formula which comprises:
(2a) at least one volatile corrosion inhibitor;
(2b) at least one anti-oxidant;
(2c) at least one alkali or alkaline-earth metal silicate or oxide;
(2d) fumed silica; and
(2e) at least one chemically active compound,
(3) a formula which comprises:
(3a) an inorganic nitrite salt;
(3b) a phenol represented by the formula: 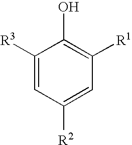
where R¹, R² and R³ are each independently selected from alkyl, aryl, alkenyl, hydroxyalkyl and hydroxyalkenyl, and where the sum of carbon atoms in R¹, R² and R³ is in the range of 3 to about 18; and
(3c) fumed silica, or
(4) a formula which comprises:
(4a) at least one strong alkali compound; and
(4b) at least one compound which yields an insoluble compound.
